(19) United States
(12) Patent Application Publication
(10) Pub. No.: US 2025/0351004 A1
(43) Pub. Date: Nov. 13, 2025

(54) TRAFFIC-AWARE LIGHTWEIGHT LAYERED OFFLOADING FRAMEWORK FOR ADAPTIVE SLICING-ENABLED SPACE-AIR-GROUND INTEGRATED NETWORK

(71) Applicant: FUZHOU UNIVERSITY, Fuzhou (CN)

(72) Inventors: Zheyi CHEN, Fuzhou (CN); Junjie ZHANG, Fuzhou (CN); Luying ZHONG, Fuzhou (CN); Jie LIANG, Fuzhou (CN); Tianying LU, Fuzhou (CN); Linrui ZHENG, Fuzhou (CN)

(73) Assignee: FUZHOU UNIVERSITY, Fuzhou (CN)

(21) Appl. No.: 18/770,746

(22) Filed: Jul. 12, 2024

(30) Foreign Application Priority Data
May 7, 2024 (CN) 202410551822.2

(51) Int. Cl. H04W 28/08; H04W 84/06

(52) U.S. Cl. CPC H04W 28/0958; H04W 84/06

(57) ABSTRACT

Provided is a traffic-aware lightweight layered offloading framework for an adaptive slicing-enabled space-air-ground integrated network (SAGIN), where the adaptive slicing-enabled SAGIN is divided into a communication access platform (CAP) and a computation offloading platform (COP), and resources on each of the CAP and the COP are managed by network slicing; an edge service provider (ESP) provides computation offloading while performing resource allocation; for the resource allocation, a dynamic traffic change is captured by using ProbSparse self-attention, and adaptive network slicing is executed in accordance with predicted traffic and a system load; and for the computation offloading, a communication process and a computation process are separated to allocate a sub-channel as required in accordance with a channel state, then a virtual machine is allocated to a task through a lightweight computation offloading algorithm, and a converged policy is extracted as a lightweight neural network for online inference.

### CROSS REFERENCE TO THE RELATED APPLICATIONS

This application is based upon and claims priority to Chinese Patent Application No. 202410551822.2, filed on May 7, 2024, the entire contents of which are incorporated herein by reference.

### TECHNICAL FIELD

The present invention relates to the technical fields of space-air-ground integrated networks, edge commutating, computation offloading, and the like, and in particular, to a traffic-aware lightweight layered offloading framework for an adaptive slicing-enabled space-air-ground integrated network.

### BACKGROUND

Emerging smart applications (for example, autonomous driving and video analysis) show characteristics such as computation intensity and latency sensitivity, while a limited computation capability of a terminal device severely limits further development and popularization thereof. To alleviate the problem, mobile edge computing (MEC) is considered as an advanced computing paradigm with promising prospects. Computation and storage resources are deployed at a network edge so that the MEC may greatly reduce network bandwidth pressure and data transmission latency. However, due to limited coverage and a fixed network architecture, existing ground infrastructures such as a base station (BS) and a road side unit cannot better satisfy a high requirement of the smart applications on service quality. On the one hand, a ground network cannot provide stable and continuous network access for users worldwide. More than 50% of regions worldwide, especially some regions with complex terrain, such as oceans and islands, still lack effective network coverage. On the other hand, as a core infrastructure in classical MEC, a ground base station is easily affected by natural disasters such as earthquakes and floods, resulting in interruption of a network communication service. In recent years, the development of space and air communication technology enables a shift in the classical MEC paradigm. Specifically, an air network composed of an unmanned aerial vehicle (UAV), a civil aircraft, and the like may provide a temporary communication service for a crowded region, and has advantages such as flexible deployment and low access latency. A satellite network composed of a low-earth orbit (LEO) satellite may provide a globally covered and universally interconnected communication service through integration with a ground network. Therefore, through complementation of advantages of the three networks, MEC enabled by a space-air-ground integrated network (SAGIN) is expected to provide a seamless and full-time global access service for smart applications to better support various application fields that need real-time data sensing and complex computation.

However, due to limited resources in the SAGIN, when a service is provided for a smart application, an unreasonable supply manner may severely reduce resource utilization efficiency and service quality. Through a software-defined network and virtualization technology, an infrastructure provider (InP) may virtualize communication and computation resources to network slices, and sell the network slices to an edge service provider (ESP) in accordance with resource pricing. The ESP may deploy different services to appropriate slices in accordance with a system state and a user requirement, so as to provide a resource-customized service. When a user initiates a computation offloading request, the ESP may receive a user task through the SAGIN and feed back a result after the task is executed by using a slice resource. Although the SAGIN has good characteristics and promising prospects, it still faces the following major challenges when designing an efficient computation offloading framework for the SAGIN.
(1) An existing SAGIN lacks a complete resource management model and is difficult to cope with a dynamic network environment effectively. To implement a full-time-domain service, the ESP needs to simultaneously access and manage a plurality of communication and computation platforms. However, due to mobility of users, user traffic in the SAGIN continuously changes over time, resulting in a non-uniform distribution of a system load in space-time. Therefore, while ensuring high quality of service (QoS) between different platforms, the ESP further needs to consider the load balance of the different platforms to reduce resource costs.
(2) Due to the limited computation capabilities of space-to-air nodes such as satellites and unmanned aerial vehicles, the existing SAGIN cannot process a computation-intensive task from the smart application efficiently. Although the SAGIN has a powerful network access capability, satellites and unmanned aerial vehicles in a realistic scenario are usually used to provide a communication service and are only equipped with limited storage and computation resources, which is difficult to process a complex task.
(3) High complexity and computation overheads of a computation offloading method severely limit the adaptability and application prospects of the computation offloading method in the SAGIN. Although there are some computation offloading methods in the SAGIN in the prior art, restricted by limited computation resources and low power-consuming architecture design of unmanned aerial vehicles, satellites, and the like, it is difficult to deploy the above methods in the SAGIN efficiently. With the increasing network size, latencies and energy consumption overheads introduced by operating these methods are difficult to be accepted.

### SUMMARY

To overcome the problem in the prior art and resolve the above challenges, the present invention fully analyzes advantages and disadvantages of communication and computation platforms in an SAGIN and explores a novel traffic-aware layered computation offloading framework for the SAGIN. Specifically, in a coverage region of the SAGIN, a user may access a service provided by an ESP in an unaware manner and upload a task to an available communication platform. In accordance with an analysis of a user traffic distribution and a platform computation capability, the ESP transmits the task from the communication platform to the computation platform for executing computation offloading, so as to achieve a balance between QoS and a renting cost. To implement reasonable task offloading, deep reinforcement learning (DRL) is introduced to interact with a dynamic SAGIN and make a decision with a target of maximizing the ESP's profit. Specially, for the problem of limited computation capabilities of unmanned aerial vehicles, satellites, and the like, a policy distillation technology is introduced to reduce the scale of a deep neural network while extracting an effective policy in the DRL and reducing the latency and energy consumption overheads required for model operation.

A technical solution used by the present invention to resolve the technical problem is: a traffic-aware lightweight layered offloading framework for an adaptive slicing-enabled space-air-ground integrated network, where the adaptive slicing-enabled SAGIN is divided into a communication access platform (CAP) and a computation offloading platform (COP), and resources on each of the CAP and the COP are managed by network slicing; an edge service provider (ESP) provides computation offloading while performing resource allocation; for the resource allocation, a dynamic traffic change is captured by using ProbSparse self-attention, and adaptive network slicing is executed in accordance with predicted traffic and a system load; and for the computation offloading, a communication process and a computation process are separated to allocate a sub-channel as required in accordance with a channel state, then a virtual machine is allocated to a task through a lightweight computation offloading algorithm, and a converged policy is extracted as a lightweight neural network for online inference.

Further, in a time slot start stage, first, slice resources are adjusted in accordance with historical traffic, load, and task completion information, and an adaptive network slicing algorithm is executed once every T^{slice} time slots to determine whether to adjust a slice; then, a user sends a to-be-offloaded task to the CAP closest to the user, and when neither a base station (BS) nor an unmanned aerial vehicle is available, the user sends the task to a satellite; after receiving an offloading request, the ESP allocates the sub-channel for the task and uploads the task to the CAP; next, the task of the user is transmitted from the CAP to the COP through a dedicated link in the adaptive slicing-enabled SAGIN; when the CAP is a ground base station and a satellite, the COP is a ground base station; when the CAP is an unmanned aerial vehicle, the COP is an unmanned aerial vehicle or a ground base station; then, after the task is transmitted to the COP, the task is allocated to a corresponding virtual machine for execution by invoking the lightweight computation offloading algorithm, and a result is transmitted back to a user device after computation is completed; and in a time slot end stage, the ESP collects task completion, system load, and user traffic information for profit computation and slice adjustment.

Further, the adaptive network slicing algorithm includes the following steps:
S1: predicting future user traffic through a Transformer-based traffic prediction model: first, construct input of an encoder and a decoder by using historical traffic information; next, send output of the encoder and the input of the decoder to the decoder, where the decoder is composed of a one-layer multi-head ProbSparse self-attention mechanism and a one-layer multi-head attention mechanism; and finally, send the output of the encoder to a multi-layer perceptron (MLP), and obtain a future traffic prediction sequence through inference;
S2: computing an anticipated system load: first, define a communication load and a computation load of a system respectively to accurately measure a slice load: the communication load under a time slot of t is represented as a ratio of a used channel resource to total channel resources, and the computation load is represented as a ratio of a sum of T^{que} and T^{exe} to

$${T}_{cop}^{m ax} ;$$

and after obtaining the system load, compute an anticipated resource requirement by multiplying a historical load by a ratio of anticipated traffic to a historical traffic; and
S3: computing an expected slice resource and determining whether to adjust the slice: if a difference between a profit and an interruption cost that are brought by adjusting the slice is greater than 0, trigger slice adjustment, and adjust communication and computation slice resources to B^{*} and F^{*} respectively, and when the difference between the profit and the interruption cost is less than or equal to 0, keep the slice resources unchanged.

Further, the lightweight computation offloading algorithm is a computation offloading method in accordance with dynamic task traffic and a quantity of virtual machines to improve resource utilization in the adaptive slicing-enabled SAGIN and the ESP's profit, and interaction between a DRL agent and an SAGIN environment is defined as a Markov decision process.

Further, in the lightweight computation offloading algorithm:
first, a network parameter and an environment are initialized; for each received task, a state sₜ is input to a participant network, and then the DRL agent explores an offloading action in a current state in accordance with π;
after receiving the action, the SAGIN environment executes the action and feeds back a state sₜ₊₁ an instant reward sₜ₊₁ and a time slot state ωₜ of a next task, where ωₜ represents whether the task is a final task in a current time slot and used for computing a discounted reward; and then, a sample of a state transition function is stored in a buffer;

When a network is updated, to reduce an impact of noise caused by the task attribute on gradient estimation, generalized advantage estimation is introduced as a network update target;
after all rounds of training are performed, the converged policy executes an offloading decision through interaction with the adaptive slicing-enabled SAGIN;
to obtain experience of a teacher model in the adaptive slicing-enabled SAGIN, the teacher model is used to interact with the environment, and a state transition sample is stored in the buffer; and then, the state transition sample is randomly selected from the buffer for policy distillation.

Further, an operating process of the traffic-aware lightweight layered offloading framework includes the following steps:
(1) collecting historical user traffic of the ESP, predicting future user traffic, computing a resource requirement of the ESP, and executing adaptive network slice adjustment by the ESP at an interval in accordance with the resource requirement;
(2) responding, by an infrastructure provider, to the resource requirement of the ESP, dividing the network slice therefor, and charging a corresponding cost;
(3) accessing and uploading a computation offloading request to the ESP by the user through the adaptive slicing-enabled SAGIN;
(4) allocating the CAP and the COP for the user in accordance with the user's location, and generating a sub-channel and virtual machine allocation policy in accordance with a task attribute and a user priority; and
(5) recording, by the traffic-aware lightweight layered offloading framework (THOAS), user traffic, state, used action, obtained reward, and new transitioned state information of each time slot in a computation offloading process, and continuously optimizing performance in accordance with the user traffic, state, used action, obtained reward, and new transitioned state information.

Compared with the prior art, first, the present invention and its preferred solutions divide the SAGIN into the CAP and the COP, and manage resources on each of the platforms by network slicing. Then, a traffic prediction method is designed to capture the dynamic traffic change by using the ProbSparse self-attention, in accordance with which an adaptive network slicing method is developed. Finally, a lightweight DRL-improved offloading method is designed to reduce network complexity and maintain good performance at the same time. In a further verification experiment, compared with other methods in the prior art, the solution of the present invention makes a better slice adjustment and offloading decision, shows higher performance in aspects of the ESP's profit, task completion time, RU, and DVR, and may greatly reduce model complexity while maintaining original performance, further proving practicability of the present invention in a resource-limited SAGIN environment.

### BRIEF DESCRIPTION OF THE DRAWINGS

The present invention is further illustrated in detail below in conjunction with the accompanying drawings and specific embodiments:

FIG. 1 is a diagram of a layered offloading framework for an adaptive slicing-enabled SAGIN in accordance with an embodiment of the present invention;

FIG. 2 is an overview diagram of a traffic-aware lightweight layered offloading framework (THOAS) designed in accordance with an embodiment of the present invention;

FIG. 3 is a schematic diagram of performance of a THOAS in aspects of traffic prediction and adaptive slicing in accordance with an embodiment of the present invention;

FIG. 4 is a schematic diagram of convergence performance of difference methods in a distillation process in accordance with an embodiment of the present invention;

FIG. 5 is a schematic diagram of performance of a THOAS at different distillation network sizes in accordance with an embodiment of the present invention;

FIG. 6 is a schematic diagram of impacts of traffic prediction on an ESP's return, cost, and profit in accordance with an embodiment of the present invention;

FIG. 7 is a schematic diagram of comparison of task completion time using different methods in accordance with an embodiment of the present invention;

FIG. 8 is a schematic diagram of impacts of user traffic on RU using different methods in accordance with an embodiment of the present invention;

FIG. 9 is a schematic diagram of impacts of the maximum task tolerant latency on DVR using different methods in accordance with an embodiment of the present invention;

FIG. 10 is a schematic diagram of impacts of a slice extension rate on an ESP's profit using different methods in accordance with an embodiment of the present invention; and

FIG. 11 is a schematic diagram of impacts of a communication latency rate on an ESP's profit using different methods in accordance with an embodiment of the present invention.

### DETAILED DESCRIPTION OF THE EMBODIMENTS

To make the features and advantages of the present invention clearer and more comprehensible, the embodiments of the present invention are described in detail below.

It should be noted that the following detailed description is exemplary and intended to further illustrate the present application. Unless otherwise stated, all technical and scientific terms used herein have same meaning as those commonly understood by those skilled in the art of the present application.

It should be noted that the terms used herein are only for describing the embodiments rather than for limiting the exemplary embodiments of the present application. As used herein, unless otherwise stated clearly in the context, a singular form is intended to include a plural form thereof. In addition, it should be understood that the terms “comprise” and/or “include” as used herein indicate the presence of features, steps, operations, components, assemblies, and/or combinations thereof.

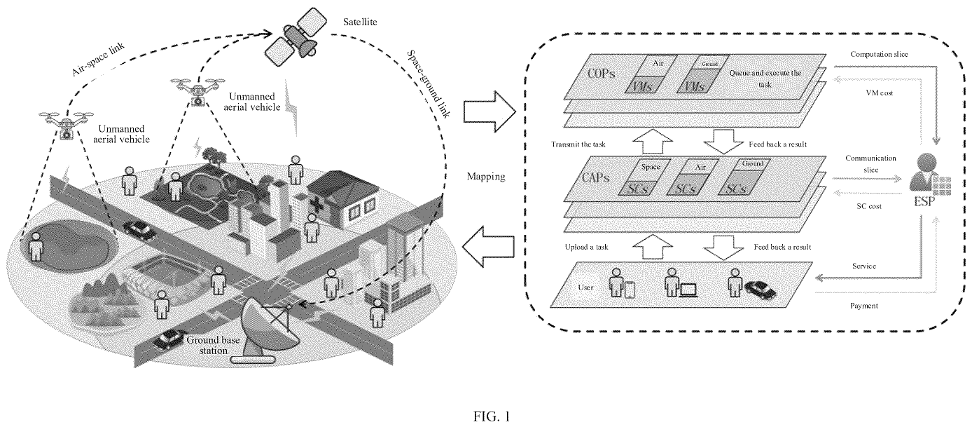

As shown in FIG. 1, a model example of a layered offloading framework for an adaptive slicing-enabled SAGIN provided by an embodiment of the present invention is composed of one satellite, one ground base station, and a plurality of unmanned aerial vehicles. The satellite, the base station, and the unmanned aerial vehicles are all equipped with a wireless access channel to provide a network access function for a user, which is referred to as a communication access platform (CAP), and a CAP set is denoted as A={a₁, a₂, . . . , a_{R}}. Based on an orthogonal frequency division multiplexing (OFDM) technology, the channel of the CAP may be divided into a plurality of orthogonal sub-channels (SCs), and the total quantity of sub-channels of aⱼ∈A is denoted as

$${B}_{j}^{ma x} .$$

The base station and the unmanned aerial vehicles are equipped with a computation unit which can provide a computation resource for a task of a smart application and is referred to as a computation offloading platform (COP), and a COP set is denoted as O={o₁, o₂, . . . , o_{S}}. The computation resource of the COP is provided in a form of a virtual machine (VM), and the total quantity of virtual machines of oⱼ∈O is denoted as

$${F}_{j}^{ma x} .$$

An InP maintains the wireless channels and the virtual machines in the SAGIN and provides them for an ESP in a form of a network slice. The ESP applies for the network slice by paying a fee to the InP, deploys a service to each network slice after obtaining a slice resource, and charges a service fee by satisfying a computation offloading request of a user. To satisfy service requirements in more scenarios and save a resource cost, the ESP needs to deploy the service to a plurality of network slices in the SAGIN while configuring an appropriate resource for each slice and performing continuous monitoring and dynamic adjustment. The quantity of sub-channels configured for the slice at aⱼ by the ESP is denoted as Bⱼ, and the quantity of virtual machines configured for the slice at oⱼ by the ESP is denoted as Fⱼ.

When the user generates the computation offloading request, the user accesses the SAGIN through the nearest available CAP and uploads a to-be-offloaded task. Then, the task is transmitted from the CAP to the COP for executing computation and then fed back to the user through the CAP after the computation is completed. If the task is completed within the user's maximum tolerant latency, the user pays a corresponding fee to the ESP. All users served by the ESP are denoted as a set U={u₁, u₂, . . . , u_{N}}, where different CAPs are located at different geographic locations and have different communication coverage. The quantity of users covered by aⱼ is denoted as Nⱼ and the quantity of users served by the ESP is a sum of all users covered by the CAP, that is:

$$N = {\sum }_{j = 1}^{R} {N}_{j} . \qquad ( 1 )$$

Due to mobility of users, user traffic in different regions in the SAGIN continuously changes over time, resulting in a non-uniform distribution of the user traffic in space-time, thereby resulting in load imbalance of the CAP and the COP. To resolve this problem, the ESP needs to monitor and analyze the user traffic and system load in the different regions so that the network slice is dynamically adjusted to improve the adaptivity and resource utilization efficiency of the service. Specifically, a time slot t∈{1, 2, . . . , T} is defined. In a start stage of the time slot t, the ESP satisfies the offloading request of the user by allocating the slice resource to the user, and in an end stage of the time slot t, the ESP collects user access traffic and system load information in each slice. Based on an analysis of the traffic and load, the ESP can predict a future user requirement, and adjust the slice in time in accordance with a package configuration provided by the InP.

### Communication Model

A task from a user uᵢ∈U is defined as a six-tuple denoted as <dᵢ, ηᵢ, ρᵢ, aᵢ, lᵢ, oᵢ>, where dᵢ is the data volume of the task, ηᵢ is the computation intensity for completing the task, ρᵢ is a priority of up uᵢ, aᵢ represents a CAP to which the user uᵢ is connected, lᵢ is the distance between uᵢ and aᵢ, and oᵢ represents a COP executing the task of the user uᵢ. The priority reflects a service level of the user, and a higher return can be obtained by completing a task of a user with a higher priority.

Compared with an unmanned aerial vehicle and a satellite, a base station has a more stable communication link and a more cost-efficient channel cost. For a region beyond the coverage of a base station, an unmanned aerial vehicle may provide a more flexible extension of communication and computation capabilities. However, for some users in a remote region (for example, sea surface and desert), a satellite may be the only available communication manner, and the users can only access a network through the satellite. Therefore, when it is required to initiate a computation offloading request, a user within the coverage of a base station and an unmanned aerial vehicle accesses the SAGIN preferentially through the base station and the unmanned aerial vehicle, and a user beyond the coverage accesses the SAGIN through a satellite.

When uᵢ initiates an offloading request, uᵢ needs to upload input data. The following different conditions are considered.
(1) If the user is within the coverage of a base station or an unmanned aerial vehicle, the user uploads a task through the base station or the unmanned aerial vehicle. The signal-to-noise ratio in the uploading process is represented as follows:

$$S N R = \frac{{p}_{u} 1 {0}^{- \frac{{P}_{loss}}{10}}}{{σ}^{2}} , \qquad ( 2 )$$

where pᵤ is uploading power, σ² is noise power, Pₗₒₛₛ=10βlog(lᵢ)+C+X_{G} is an average path loss, β is a path loss index, C is a constant depending on an operating frequency and an antenna gain, and X_{G} is a Gaussian random variable.
(2) If the user is beyond the coverage of a base station or an unmanned aerial vehicle, the user uploads a task through a satellite, and the signal-to-noise ratio in the data transmission process is defined as follows:

$$S N R = \frac{{p}_{u} {G}_{u} {G}_{s} {λ}^{2} 1 {0}^{- \frac{{F}_{rain}}{10}}}{{{σ}^{2} ( 4 π {l}_{l} )}^{2}} , \qquad ( 3 )$$

where Gᵤ and Gₛ respectively are antenna gains of the user and the satellite, λ is a wavelength, and Fᵣₐᵢₙ is rain attenuation and conforms to Weibull distribution.

When the quantity of sub-channels allocated by the ESP to uᵢ is bᵢ^{t}, in accordance with Shannon-Hartley theorem, the rate of uploading the task by uᵢ is as follows:

$${r}_{j} = {b}_{i} H {log}_{2} ( 1 + SNR ) , \qquad ( 4 )$$

where H is the bandwidth of a sub-channel. Therefore, the time required by uᵢ to upload the task to the CAP is as follows:

$${T}_{i}^{u p} = \frac{{d}_{i}}{{r}_{i}} . \qquad ( 5 )$$

Although a satellite may also provide a computation service, its energy consumption and resource cost are very expensive compared with a ground base station. Therefore, in a realistic scenario, a satellite is inappropriate to be used as a computation node because its cost usually exceeds the benefit it generates. Considering that a satellite is advantageous in that it is capable of connecting a user in a remote region and a ground base station with rich resources at the same time, a task of the user in the remote region may be transmitted to the ground base station through a satellite-ground link for executing offloading, which saves the computation cost while implementing remote communication. In addition, an unmanned aerial vehicle may provide a flexible computation service by carrying a small computation unit. However, limited by a computation capability and battery energy storage, the unmanned aerial vehicle may not satisfy all task requirements. In this case, it is required to consider whether to appropriately forward a task received by the unmanned aerial vehicle to a ground base station for execution.

Therefore, after a task of a user is transmitted to the SAGIN, an appropriate COP needs to be allocated to the user in accordance with a CAP the user accesses. When the user accesses through a ground base station, the task may be executed on the base station directly. When the user accesses through a satellite, the task needs to be forwarded to a ground base station for execution through a satellite-ground link. When the user accesses through an unmanned aerial vehicle, it is determined whether to forward the task to a ground base station for execution in accordance with the task requirement and network state. If it is required to forward the task, the task is forwarded to a ground base station for execution through unmanned aerial vehicle-satellite and satellite-ground links. Otherwise, the task is executed on the unmanned aerial vehicle. Correspondingly, the time for forwarding the task of uᵢ between different platforms is defined as follows:

$${T}_{i}^{tran} = \{ \begin{matrix}0 , {a}_{i} = {o}_{i} , \\ \frac{{d}_{i}}{{R}^{s 2 g}} , {a}_{i} ∈ Satellites , \\ \frac{{d}_{i}}{{R}^{a 2 s}} + \frac{{d}_{i}}{{R}^{s 2 g}} , otherwise\end{matrix} . \qquad ( 6 )$$

where R^{s2g} represents a communication rate between the satellite and the base station, and R^{a2s} represents a communication rate between the unmanned aerial vehicle and the satellite.

### Computation Model

After a task is transmitted to an appropriate COP, the COP allocates the task to a virtual machine for executing computation, and the virtual machine may execute a plurality of tasks. For the task of uᵢ, the queuing time required by the task from reaching the virtual machine to starting execution is as follows:

$${T}_{i}^{que} = {\sum }_{k = 1}^{\vert Q \vert} \frac{{d}_{k} {η}_{k}}{{f}^{edge}} , \qquad ( 7 )$$

where Q represents an existing task queue when the task reaches the virtual machine, and f^{edge} represents the computation capability of the virtual machine in the COP. In addition, the actual execution time of the task of uᵢ in the virtual machine is as follows:

$${T}_{l}^{exe} = \frac{{d}_{i} {η}_{i}}{{f}^{edge}} , \qquad ( 8 )$$

Finally, an execution result is fed back to the user through the CAP again. Compared with the input data, the data volume of the output result is usually small, and therefore, the time for feeding back the result may be ignored.

### Return and Cost Model

Comprehensively considering the communication and computation models, the total time for processing the task of uᵢ is as follows:

$${T}_{i}^{total} = {T}_{i}^{up} + {T}_{i}^{tran} + {T}_{i}^{que} + {T}_{i}^{exe} . \qquad ( 9 )$$

On the one hand, the ESP charges the user a certain fee in accordance with a service it provides. If the task can be completed within the user's maximum tolerant latency T^{max}, the ESP may obtain a return Φ. Otherwise, there is no return. In a time slot t, a return obtained by the ESP from uᵢ is defined as follows:

$${φ}_{i}^{t} = \{ \begin{matrix}Φ , if {T}_{i}^{total} \leq {T}^{max} \\ 0 , otherwise\end{matrix} . \qquad ( 10 )$$

Returns obtained by completing tasks of users of different priorities are different. Therefore, the total return of the ESP in the time slot t is defined as follows:

$${R}^{t} = {\sum }_{i = 1}^{N} {φ}_{i}^{t} {ρ}_{i} . \qquad ( 11 )$$

On the other hand, the ESP needs to pay a certain fee for renting sub-channel and virtual machine resources in the SAGIN, and the fee is in direct proportion to the quantity of rented resources. Therefore, in the time slot t, the total cost required by the ESP for renting the channel and VM resources is as follows:

$${C}^{t} = {\sum }_{j = 1}^{R} {B}_{j} {ζ}_{j}^{b} + {\sum }_{j = 1}^{S} {F}_{j} {ζ}_{j}^{f} , \qquad ( 12 )$$

where ζ^{b} and ζ^{f} respectively represent unit prices of renting the sub-channel and virtual machine resources.

Based on the models provided above, the optimization target is to maximize the long-term profit of the ESP. The optimization problem is formally defined as follows:

$$P 1 : {max}_{B , F , π} {\sum }_{t = 1}^{T} ( {R}^{t} - {C}^{t} ) \qquad ( 13 )$$

$$s . t . C 1 : {B}_{j} \leq {B}_{j}^{max} , ∀ j , ∀ t ,$$

$$C 2 : {F}_{j} \leq {F}_{j}^{max} , ∀ j , ∀ t .$$

where B and F respectively represent communication and computation slice policies, and π represents a computation offloading policy. Constraints C1 and C2 respectively represent that the quantity of sub-channels and virtual machines requesting for slicing cannot exceed the maximum quantity of sub-channels and virtual machines of the access platform. It should be noted that when user traffic fluctuates, the offloading policy may not satisfy offloading requirements of all users. At this time, slice adjustment is required to improve a slice resource capacity, and such adjustment also affects the offloading policy. Therefore, decisions between network slicing and computation offloading are coupled with each other, and the designed policy needs to implement reasonable computation offloading and adapt to changes of the user traffic and the slice resource in a system at the same time.

### Overview of the Proposed Technical Solution THOAS

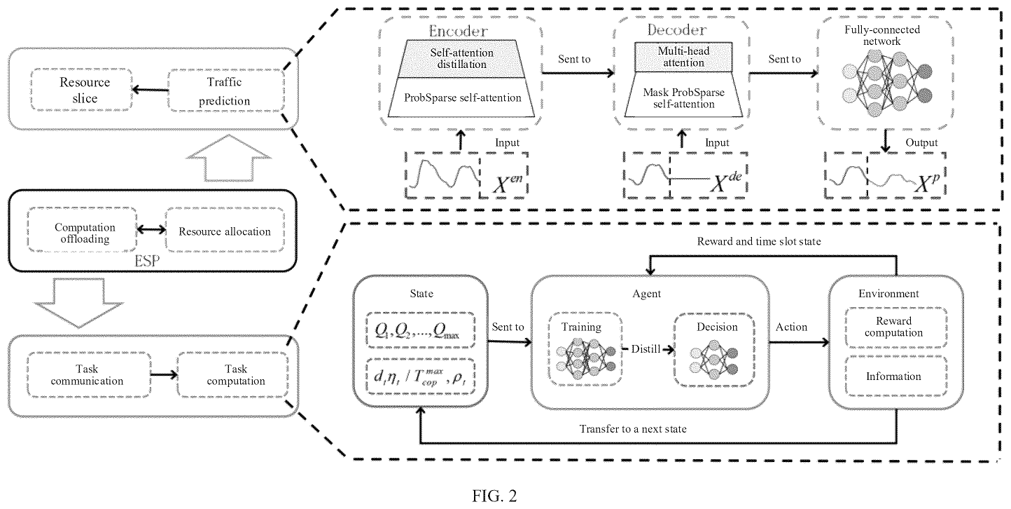

To resolve the optimization problem and maximizing the ESP's profit, the present invention proposes a THOAS, namely a traffic-aware lightweight layered offloading framework, configured to support an adaptive slicing-enabled SAGIN. As shown in FIG. 2, an ESP provides computation offloading while performing resource allocation. For the resource allocation, a new traffic prediction method is designed to analyze and predict a future traffic fluctuation, and then adaptive network slicing is executed in accordance with predicted traffic and a system load. For the computation offloading, first, a communication process and a computation process are separated to allocate a sub-channel as required in accordance with a channel state. Then, improved DRL is designed to effectively allocate a virtual machine to a task, where a converged policy is extracted as a lightweight neural network for online inference and better adapting to the SAGIN with a limited resource.

An overview of the THOAS is as shown in an algorithm 1. In a time slot start stage, first, slice resources are adjusted by invoking an algorithm 2 in accordance with historical traffic, load, and task completion information (lines 2 and 3). Since frequent adjustment causes excessive system overheads, it is considered that the algorithm 2 is executed once every T^{slice} time slots to determine whether to adjust a slice. Then, a user sends a to-be-offloaded task to a CAP closest to the user (for example, a ground base station or an unmanned aerial vehicle), and when neither a ground base station nor an unmanned aerial vehicle is available, the user sends the task to a satellite (line 5). After receiving an offloading request, the ESP allocates the sub-channel for the task and uploads the task to the CAP (line 6). Then, the task of the user is transmitted from the CAP to the COP through a dedicated link in the SAGIN (line 7). When the CAP is a ground base station and a satellite, the COP is a ground base station. When the CAP is an unmanned aerial vehicle, the COP is an unmanned aerial vehicle or a ground base station, which depends on a load condition of the unmanned aerial vehicle. After the task is transmitted to the COP, the task is allocated to an appropriate virtual machine for execution by invoking an algorithm 3, and a result is transmitted back to a user device after computation of the task is completed (lines 8 and 9). In a time slot end stage, the ESP collects task completion, system load, and user traffic information for subsequent profit computation and slice adjustment (line 10).

To better manage and control loads of different access platforms, the maximum task tolerant latency is divided into the maximum communication tolerant latency

$${T}_{cap}^{max}$$

and the maximum computation tolerant latency

$${T}_{cop}^{max} .$$

Assume that ω represents the ratio of the maximum communication tolerant latency to the maximum computation tolerant latency, that is,

$${T}_{cap}^{max} = ω {T}^{max} and {T}_{cop}^{max} = ( 1 - ω ) {T}^{max} .$$

Further, an on-demand channel allocation policy is defined as follows:

$${b}_{j} = ⌈ \frac{{d}_{j}}{{T}_{com}^{max} H log ( 1 + SNR )} ⌉ , \qquad ( 14 )$$

where SNR depends on the CAP to which uᵢ is connected.

Algorithm 1 THOAS algorithm

| | Input: B^{max} , F^{max} , ζ^{b} , and ζ^{f} |
|---|---|
| | Output: an ESP's slicing and offloading policy |
| 1. | for t = 1,2,...,T do |
| 2. | if t % T^{slice} == 0 |
| 3. | invoke an algorithm 2 to adjust a slice resource; |
| 4. | for i = 1,2,...,N ⱼ do |
| 5. | send, by a user, an offloading request to a CAP |
| 6. | allocate a sub-channel for the user and upload a task to the |
| | CAP; |
| 7. | transmit the task from the CAP to a COP; |
| 8. | invoke an algorithm 3 to dispatch and execute the task; |
| 9. | feed back a task execution result; |
| 10. | collect task completion, system load, and user traffic |
| | information; |
| 11. | end for |
| 12. | end for |

### Adaptive Network Slicing Method

The ESP's system resource management performance may be significantly improved by analyzing the load state and the predicted resource requirement. Generally, the system load is affected by the user traffic and the service requirement. An existing advanced prediction model may predict a future request mode of a user by capturing a historical traffic change feature. However, the user's service requirement depends on the service type provided by the ESP and may be obtained by analyzing the historical load. Therefore, a future load condition of the ESP is deduced by combining user traffic prediction and service requirement analysis. When an anticipated load is obviously higher or lower than a current slice capacity of the ESP, the load is maintained in a reasonable range by adjusting the slice resource. In addition, it should be noted that frequent slice adjustment may result in service interruption and affect the QoS. Therefore, the ESP needs to comprehensively consider these elements to determine an appropriate time for slice adjustment.

In the SAGIN, a traffic mode of a user's offloading request includes a long-term requirement change (for example, an application popularity impact) and a short-term load fluctuation (for example, user movement), where the long-term requirement change has a more significant impact on resource utilization efficiency in the SAGIN. Compared with a prediction model based on an RNN and a CNN, Transformer shows an outstanding capability of capturing long-term memory dependence and can better learn a global mode and a local trend of a user access service. In addition, a slice window in the proposed adaptive network slicing is dynamic, and therefore, an input traffic sequence is usually of unequal length. Benefiting from a self-attention mechanism, Transformer can process input data of different time scales without the need for adjusting a model structure and has better practicability in traffic prediction of different slice windows. Based on user traffic prediction and task requirement analysis, an adaptive network slicing method is provided and includes the main steps as shown in an algorithm 2.
S1: predicting future user traffic. A Transformer-based traffic prediction model is designed, and first, input of an encoder and a decoder is constructed by using historical traffic information (line 1). X his represents historical access traffic, X^{cur} represent a traffic sequence collected by a current slice window, and X^{o} represents time sampling of a to-be-predicted traffic sequence. When an encoder is constructed, a classical self-attention mechanism needs to compute attention weights of all historical time slots, resulting in relatively high computation complexity. To alleviate the problem, ProbSparse self-attention is used in the encoder and self-attention distillation is used between layers to reduce computation overheads (line 2). Specifically, a feature extraction process from a jₜₕ layer to a j+1ₜₕ layer is defined as follows:

$${X}_{j + 1}^{e n} = Max Pool ( ELU ( Conv 1 d ( {[ {X}_{j}^{e n} ]}_{attention} ) ) ) , \qquad ( 15 )$$

$${[ \cdot ]}_{attention} = Softmax ( \frac{\overline{Q} {K}^{T}}{\sqrt{d}} ) V , \qquad ( 16 )$$

where [⋅]ₐₜₜₑₙₜᵢₒₙ represents sparse self-attention, d is a dimension of

$${X}_{l}^{t} ,$$

Conv1d represents a one-dimensional convolution on a time sequence, ELU is an activation function, and MaxPool is a maximum pooling operation. Then, output of the encoder and the input of the decoder are sent to the decoder, where the decoder is composed of a one-layer multi-head ProbSparse self-attention mechanism and a one-layer multi-head attention mechanism (line 3). Finally, the output of the encoder is sent to MLP, and a future traffic prediction sequence is obtained through inference (line 4).

S2: computing an anticipated system load. Since the system load is in positive correlation with the user traffic, a fluctuation of the load may be deduced through a traffic change. A communication load and a computation load of a system are defined respectively to accurately measure a slice load (line 5). Specifically, the communication load under a time slot of t is represented as a ratio of a used channel resource to total channel resources, and the computation load is represented as a ration of a sum of T^{que} and T^{exe} to

$${T}_{cop}^{max} .$$

After the system load is obtained, an anticipated resource requirement is computed by multiplying a historical load by a ratio of anticipated traffic to a historical traffic.

S3: computing an expected slice resource and determining whether to adjust the slice. 1+δ times a load peak is taken as the expected slice resource, where δ represents a proportion of resources additionally purchased by the ESP (line 6). On the one hand, adjusting the slice may affect the ESP's return and bring additional system overheads. On the other hand, a process of adjusting the virtual machine may result in unavailability of the service, thereby bringing an interruption cost. Therefore, the ESP needs to comprehensively consider these elements to determine whether to adjust the slice. A profit brought by adjusting the slice is defined as follows:

$$Δ P = Δ R - Δ C , \qquad ( 17 )$$

where ΔR represents a difference between the ESP's anticipated return after adjusting the slice and the ESP's anticipated return when maintaining a current slice, and ΔC represents a difference between the ESP's cost after adjusting the slice and the ESP's cost when maintaining the current slice (line 7). An interruption cost caused by adjusting the slice is defined as follows:

$${C}^{i n t} = {\sum }_{t = 1}^{{T}^{i n t}} {\sum }_{i = 1}^{{N}_{j}} Φ {ρ}_{i} , \qquad ( 18 )$$

where T^{int} represents the quantity of time slots required when adjusting the slice (line 8). When a difference between the profit and the interruption cost that are brought by adjusting the slice is greater than 0, slice adjustment is triggered, and communication and computation slice resources are adjusted to B^{*} and F^{*} respectively, otherwise the slice resources are kept unchanged (lines 9 and 10).

Algorithm 2 adaptive network slicing
Input: a historical system state
Output: B^{t+1} and F^{t+1}

| | |
|---|---|
| 1. | obtain traffic input vectors: X^{en} ← X^{his} and X^{de} ← Concat (X^{cur}, X⁰); |
| 2. | compute output of an encoder: H₁ = Encoder(X^{en} ); |
| 3. | compute input of a decoder: H₂ = Decoder(H₁, X^{de} ); |
| 4. | obtain future traffic: Z^{p} = MLP(H₂); |
| 5. | compute a future system load: |
| | ${B}^{need} = \frac{{B}^{used}}{{B}^{t}} \frac{{X}^{p}}{{X}^{cur}} , {F}^{need} = \frac{{F}^{t} ( {T}^{que} + {T}^{e xe} )}{{T}_{cop}^{m ax}} \frac{{X}^{p}}{{X}^{cur}} ;$ |
| 6. | compute an expected slice resource: |
| | B* = (1 + δ) max(B^{need} ) and F* = (1+δ) max(F^{need} ); |
| 7. | compute an expected profit ΔP; |
| 8. | compute an expected interruption cost C^{int}; |
| 9. | if ΔP − C^{int} > 0 then |
| 10. | B^{t+1} = B*, F^{t+1} = F*; |

### Lightweight Computation Offloading Method

Based on adaptive network slicing, a computation offloading method in accordance with dynamic task traffic and the quantity of virtual machines is further designed to improve resource utilization in the SAGIN and the ESP's profit. In recent years, DRL has been widely used to resolve complex problems such as computation offloading and task dispatch. Although a deep network structure increases a fitting capability of the DRL, more computation costs are undoubtedly introduced, which limits application of the DRL in the resource-limited SAGIN. In an actual decision process, when facing a limited search space, a policy generated after DRL agent training is mainly affected by some network parameters. Therefore, a lightweight decision model is obtained by compressing an original deep network, which helps improve training and inference efficiency of the DRL while maintaining its superior decision capability. As an emerging learning paradigm, knowledge distillation may transfer knowledge from a deep teacher network to a shallow student network and has been widely used in model compression. For actor-critic-based DRL, an action probability distribution of a teacher model may be collected through interaction between a trained actor network and an environment and may be used as a target of distillation. Then, output of a student model may be consistent with that of the teacher model by training a parameter of the student model through a loss function and an optimizer. Based on this idea, a novel lightweight computation offloading method combining DRL and knowledge distillation is proposed. Specifically, the interaction between a DRL agent and an SAGIN environment is defined as a Markov decision process, where a state space, an action space, and a reward function are defined as follows.

The state space: a VM task queue of the ESP's slice, a task attribute, and a user priority for task sending are included. To better capture a state feature, a maximum computation tolerable latency and a central processing unit (CPU) cycle required by the task are converted into a computation frequency to represent a computation resource required by the task. Therefore, the state space is defined as follows:

$${s}_{t} = \{ {Q}_{1} , {Q}_{2} , … {Q}_{max} , \frac{{d}_{t} {η}_{t}}{{T}_{cop}^{max}} , {ρ}_{t} \} . \qquad ( 19 )$$

The action space: when a virtual machine of an unmanned aerial vehicle is difficult to satisfy offloading requirements of all tasks, the task may be forwarded to a BS for offloading. Therefore, to enable the algorithm to be adapted to the unmanned aerial vehicle and a ground base station, action spaces adapted to different scenarios are defined. When the task is executed at the BS, the action space includes a target virtual machine. When the task is executed on the unmanned aerial vehicle, the action space includes the target virtual machine and forwarding to the BS for execution. VMG is used to represent that the task is forwarded to the BS through an SAGIN wireless link, and the task is to be reallocated to a virtual machine at the BS. Therefore, the action space is defined as follows:

$${a}_{t} ∈ \{ {VM}_{G} , {VM}_{1} , {VM}_{2} , … , {VM}_{max} \} . \qquad ( 20 )$$

the reward function: in accordance with a Pl optimization target, the reward function is defined as a profit obtained by completing the task. When the task is forwarded from the unmanned aerial vehicle to the BS, the profit is computed at the BS. A small positive value is used as a reward to distinguish between a forwarded task and a failed task. Therefore, tₜ is defined as follows:

$${r}_{t} = \{ \begin{matrix}ε , if {a}^{t} = {VM}_{G} , \\ {υ}_{i}^{t} {ρ}_{i} , otherwise\end{matrix} . \qquad ( 21 )$$

In accordance with the above definitions, an algorithm 3 outlines the key steps of the proposed computation offloading method. First, a network parameter and an environment are initialized (line 2). For each received task, a state is input to a participant network, and then the DRL agent explores an offloading action in a current state in accordance with π (line 4).

After receiving the action, the SAGIN environment executes the action and feeds back a state sₜ₊₁ an instant reward sₜ₊₁, and a time slot state ωₜ of a next task, where ωₜ represents whether the task is a final task in a current time slot and used for computing a discounted reward (line 5). Then, a sample of a state transition function is stored in a buffer.
when a network is updated, to reduce an impact of noise caused by the task attribute on gradient estimation, generalized advantage estimation is introduced as a network update target and defined as follows:

$${Â}_{t} = {\sum }_{k = 0}^{∞} {( γ λ )}^{k} {δ}_{t + l} , \qquad ( 22 )$$

$${δ}_{t} = {R}_{t} + γ V ( {s}_{t + 1} ) - V ( {s}_{t} ) , \qquad ( 23 )$$

where γ is a reward discount rate, λ is an advantage function discount rate, δₜ is a time differentiation error, Rₜ is a reward, and V is a state value function (lines 6 and 7). Since an action of each task may affect the queuing time and execution time of a subsequent task, a reward for a subsequent task in the current time slot needs to be used for computing the discounted reward, and R is defined as follows:

$${R}_{t} = {\sum }_{k = 0}^{N - 1} {γ}^{k} {R}_{t + k + 1} . \qquad ( 24 )$$

However, due to a dynamic change in the task traffic and the quantity of virtual machines, the step of an update policy in a policy gradient is difficult to be determined. To resolve the problem, a clipping mechanism is used to ensure that each update is within a certain range (line 8). Therefore, an objective function of policy update is defined as follows:

$${L}^{actor} ( θ ) = E [ min ( r ( θ ) Â ( {s}_{t} , {a}_{t} ) , \tilde{r} ( {θ}_{t} ) Â ( {s}_{t} , {a}_{t} ) ) ] , \qquad ( 25 )$$

wherein r^{(θ)} is a ratio between sample weights of a new policy and an old policy and defined as follows:

$$r ( θ ) = \frac{{π}_{θ} ( {a}_{t} \vert {s}_{t} )}{{π}_{o l d} ( {a}_{t} \vert {s}_{t} )} , \qquad ( 26 )$$

To improve stability of policy update, first, a clipping function is used to avoid an excessive policy update range. At the same time, to prevent a fixed confidence interval from causing excessively slow update, a two-layer dynamic confidence interval is designed and defined as follows:

$$\tilde{r} ( {θ}_{t} ) = \{ \begin{matrix}1 - {α}_{t} , if ( 1 - {α}_{t} ) \leq r ( {θ}_{t} ) < 1 , \\ 1 + {α}_{t} , if 1 < r ( {θ}_{t} ) \leq ( 1 + {α}_{t} ) , \\ clip ( r ( {θ}_{t} ) , 1 - ò , 1 + ò ) , othwewise\end{matrix} , \qquad ( 27 )$$

wherein ò is a clipping ratio, αₜ is a dynamic confidence factor dynamically adjusted in accordance with a temporal differentiation error, and, is defined as follows:

$${α}_{t} = \{ \begin{matrix}κ {α}_{t - 1} , {δ}_{t - 1} \geq 0 , \\ {α}_{t - 1} / κ , otherwise\end{matrix} , \qquad ( 28 )$$

[symbol] is used to control an update speed of the dynamic confidence factor. Then, a critic network is optimized by minimizing L^{critic}(ϕ) (line 9) represented as follows:

$${L}^{critic} ( ϕ ) = {E ( {R}_{t} + γ V ( {S}_{t + 1} ) - V ( {S}_{t} ) )}^{2} \qquad ( 29 )$$

After all rounds of training are performed, the converged policy executes an offloading decision through interaction with the adaptive slicing-enabled SAGIN. Based on a structure of a neural network, the complexity of the above method is

$$O ( {\sum }_{p = 0}^{P} {n}_{p} {n}_{p - 1} ) ,$$

where P and nₚ respectively are the quantity of layers and the quantity of neural units at each layer. Therefore, to better adapt to limited computation units in the SAGIN, algorithm complexity needs to be reduced by reducing P and nₚ.

To obtain experience of a teacher model (that is, a converged model) in the SAGIN, the teacher model is used to interact with the environment, and a state transition sample is stored in the buffer (line 12). Then, the state transition sample is randomly selected from the buffer for policy distillation (line 13).

for each of the samples, a policy of a teacher network is used as a learning target and an Adam optimizer is used to train a student network to output an action probability distribution similar to that output by the teacher network (line 14). This process may be considered as supervised learning. A loss function is constructed by using a soft label and Kullback-Leibler (KL) divergence and defined as follows:

$${L}^{dis} ( {θ}_{s} ) = {\sum }_{i = 1}^{K} Softmax ( \frac{{q}_{k}^{T}}{τ} ) ln \frac{Softmax ( \frac{{q}_{k}^{T}}{τ} )}{Softmax ( {q}_{k}^{S} )} . \qquad ( 30 )$$

where

$${q}_{k}^{T} and {q}_{k}^{s}$$

are action probability distributions output by the teacher model and the student model respectively, and τ is a temperature. Compared with direct use of a Q value as a distillation target, using an action probability after being subjected to softmax as the distillation target may result in a smaller variance of the loss function, which is easier to converge the student network. In addition, in the proposed Markov model, a condition in which rewards are very different may occur on two actions with similar action probabilities. Therefore, a high-reward action of the teacher model may be more effectively transmitted to the student model by using a low-temperature softmax sharpening action probability distribution.

The depth and width of a neural network origin model may be effectively reduced through policy distillation. Compared with direct use of an agent with a small-scale network, efficiency of exploring a high-reward action and fitting a complex policy by a large-scale network in a training process is higher. At the same time, a distillation process may also be converged rapidly. Therefore, it is worthy of balancing system performance and overheads by distilling the large-scale network rather than using the small-scale network.

Algorithm 3 DRL-based lightweight computation offloading
input: VM and Task
output: π*
initialize: π and V

| | |
|---|---|
| 1. | for epoch = 1, 2, . . . , E do |
| 2. | initialize an environment: s₀ ← env · init(); |
| 3. | for task = 1, 2, . . . , Nⱼ do |
| 4. | select an offloading action: aₜ ← π_{θ} (sₜ); |
| 5. | execute aₜ in the environment: sₜ₊₁, rₜ, ωₜ = env · step(aₜ); |
| 6. | compute a discounted reward: |
| | ${R}_{t} = {\sum }_{k = 0}^{N - 1} {γ}^{k} \cdot {r}_{t + k + 1} ;$ |
| 7. | compute an advantage: |
| | ${\hat{A}}_{t} = {\sum }_{k = 0}^{∞} {( γ λ )}^{k} {δ}_{t + k} ;$ |
| 8. | minimize L^{actor} (θ) to update π; |
| 9. | minimize L^{critic} (ϕ) to update V; |
| 10. | end for |
| 11. | end for |
| 12. | interact with the environment by using a teacher model and |
| | store a state transition function in a buffer |
| 13. | take samples: K * (sₜ, aₜ, rₜ, sₜ₊₁) ← RB · Sample(K); |
| 14. | minimize L^{dis} (θₛ) by using Adam to update a student model. |

In accordance with the above framework design, an operating process of the design may be obtained as follows:
(1) The THOAS collects historical user traffic of the ESP, predicts future user traffic, and computes a resource requirement of the ESP, and then the ESP executes adaptive network slice adjustment at an interval in accordance with the resource requirement.
(2) An infrastructure provider responds to the resource requirement of the ESP, divides the network slice for the ESP, and charges a corresponding cost.
(3) The user accesses and uploads a computation offloading request to the ESP through the SAGIN.
(4) The THOAS allocates the appropriate CAP and COP for the user in accordance with the user's location, and generates a sub-channel and virtual machine allocation policy in accordance with a task attribute (for example, a task size, a computation requirement, and the maximum tolerant latency) and a user priority.
(5) The THOAS records user traffic, state, used action, obtained reward, and new transitioned state information of each time slot in a computation offloading process, and continuously optimizes performance in accordance with the user traffic, state, used action, obtained reward, and new transitioned state information.

### Method Evaluation

Based on a work station equipped with an eight-core Intel (R) Xeon (R) Silver 4208 CPU@3.2 GHZ, NVIDIA Geforce RTX 3090 GPU, and 32 GB RAM, the proposed system and THOAS are implemented by using PyTorch. A dynamic user request is constructed in the SAGIN by using a real data set of Milan cellular traffic, where three types of services, namely message, call, and Internet, are included. User request traffic within two months is recorded in a sampling frequency of 10 minutes. Specifically, three regions are selected, and Internet service traffic recorded in each sampling is used as the quantity of user requests in one time slot. In an experiment, main parameters are set as shown in Table 1, where different parameters of the satellite, the unmanned aerial vehicle, and the base station are represented by a triple list.

TABLE 1
Parameter Setting

| Parameter | Value | Parameter | Value | |
|---|---|---|---|---|
| R | [10, 15, 20] | Gᵤ | 10 | dB |
| S | [0, 3, 6] | Gₛ | 30 | dB |
| Nⱼ | [[1~4], [1~6], [1~10]] | H | 1 | Mbps |

| | | | | |
|---|---|---|---|---|
| dᵢ | [200~500] | kB | f^{edge} | [0, 1.5 GHz, 2.0 GHz] |

| | | | | |
|---|---|---|---|---|
| ηᵢ | [1~10] | T^{max} | 1.0 | s |

| ρᵢ | {1, 2, 3} | | ζ^{b} | [CNY 0.2, CNY 0.1, |
|---|---|---|---|---|
| | | | | CNY 0.1] |
| lᵢ | [1000 kM, [0.1~5] kM, | | ζ^{f} | [0, CNY 0.4, |
| | [0.1~10] kM] | | | CNY 0.2] |
| pᵤ | 100 | mW | Φ | CNY 1.0 |
| σ² | −110 | dBm | ω | 0.2 |
| θ | 2 | | δ | 0.05 |
| β | 3.04 | | T^{int} | 3 |
| R^{s2g} | 15 | Mbps | ò | 0.2 |
| R^{a2s} | 20 | Mbps | τ | 0.01 |

In addition to the ESP's profit and task completion time, the THOAS is further evaluated by using the following performance indexes.
(1) Resource utilization (RU): a ratio of the SCs and VMs that are used to execute the task to the resources rented by the ESP.
(2) Deadline violation ratio (DVR): a ratio of the quantity of tasks whose latency exceeds the maximum tolerable latency to the total quantity of tasks.

The THOAS is compared with the following reference methods to verify its superiority.
(1) GL-TCN: the time convolution network is used to perform traffic and adaptive slicing and uses a dilated convolution and a shortcut connection to capture long-and short-term dependency in a traffic sequence;
(2) PredRNN: the PredRNN uses long-and short-term memory to perform traffic and adaptive slicing, and combines a recurrent neural network and a gating mechanism to capture long-and short-term dependence in a traffic sequence;
(3) Static: the Static does not use an adaptive network slicing method (that is, the ESP's resource remains unchanged), and the offloading algorithm is consistent with the THOAS.
(4) PPO-TO: the proximal policy optimization-penalty policy is used to make an offloading decision and introduces a penalty function to improve stability of policy update.
(5) DDQN-TS: the DDQN-TS uses double DQNs to make an offloading decision and introduces a target network to resolve a problem of overestimation of a Q value in the DQN.
(6) DQNM: the deep Q-network is used to make an offloading decision and uses a deep neural network to approximate the Q-network and select an action with the maximum Q value as a candidate action.

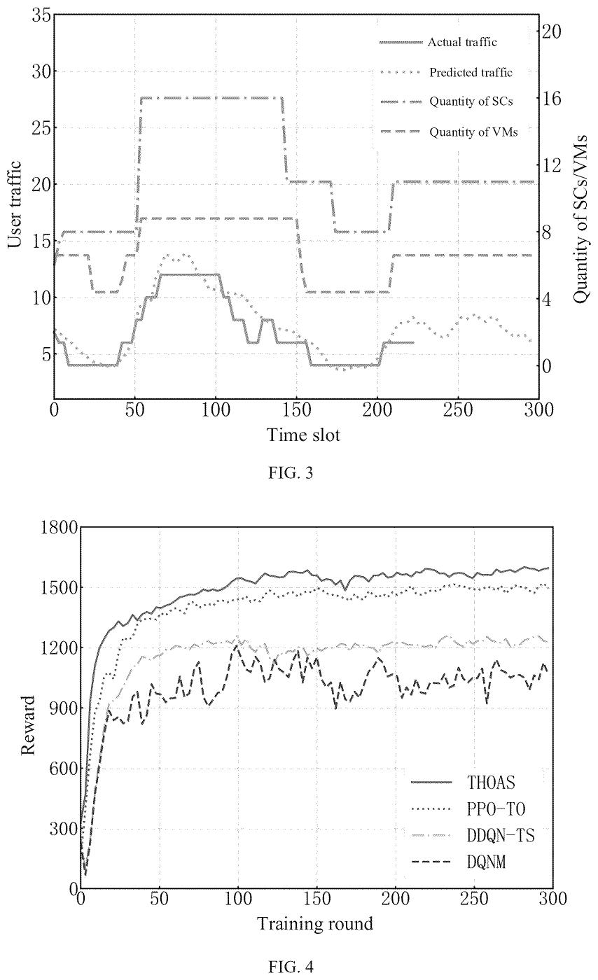

First, the THOAS's capability of capturing a traffic change and adaptively adjusting a resource (including the SC and the VM) is evaluated. As shown in FIG. 3, when there is a phased increase in user traffic, the THOAS may accurately predict this increase trend. Correspondingly, the THOAS is to adaptively adjust a slice resource (that is, increasing the quantity of sub-channels and virtual machines rented by the ESP) so that the rented resource can satisfy a user requirement. When the user traffic is decreasing, the THOAS can also adaptively adjust the slice resource again at an appropriate time to reduce resource waste and the ESP's cost of renting the resource. It should be noted that the THOAS does not respond to a tiny traffic fluctuation by adjusting the slice resource. The reason is that the THOAS executes traffic prediction and slice resource adjustment at an interval. In this way, system operation overheads may be effectively reduced, and service interruption caused by frequent slice adjustment may also be avoided at the same time.

Then, the convergence of different methods and distillation processes is evaluated. As shown in FIG. 4, the DDQN-TS obtains a higher reward than the DQNM and shows better convergence. The reason is that the Q network in the DQNM is used for action evaluation and selection simultaneously, resulting in the problem of overestimation of the Q value and reducing a correlation between samples, and the DDQN-TS alleviates the problem by using the target network. Compared with the DQNM and the DDQN-TS, the PPO-TO can converge a higher reward in a training process because it improves the accuracy of action-value estimation by using an advantage function. At the same time, proximal policy clipping used by the PPO-TO limits the step of policy update and alleviates an impact of environmental dynamics such as a traffic fluctuation and a resource change on policy update to a certain extent. However, limitation of this fixed interval also reduces the efficiency of policy update, resulting in insufficient utilization efficiency of the sample. Based on this, the THOAS uses a clipping policy with a dynamic confidence interval so that the range of policy update may be adjusted in accordance with a sample advantage, which significantly improves the utilization efficiency of the sample. Therefore, the THOAS can converge better performance.

Then, impacts of using different network scales on the THOAS performance in the distillation process are evaluated. As shown in FIG. 5, when the student model uses a network scale similar to that of the teacher model, performance of a distilled student model is only slightly reduced. When the network scale of the student model is continuously reduced to 6% of that of the teacher model, the distilled student model may still maintain 73% of the original performance. The reason is that when facing a discrete action space in the SAGIN, a policy generated by a trained DRL model is mainly only affected by some network parameters. The proposed policy distillation outputs an action probability distribution by using the teacher model and transfers a core network parameter of the teacher model to a shallow network. In this way, the accuracy of a policy generated by the teacher model is maintained and the redundancy of a network structure is also reduced. Therefore, the proposed THOAS can greatly reduce the network scale of an agent on the premise of maintaining superior performance by using a distillation technology, so as to better adapt to an SAGIN environment in which computation capabilities of different levels are deployed.

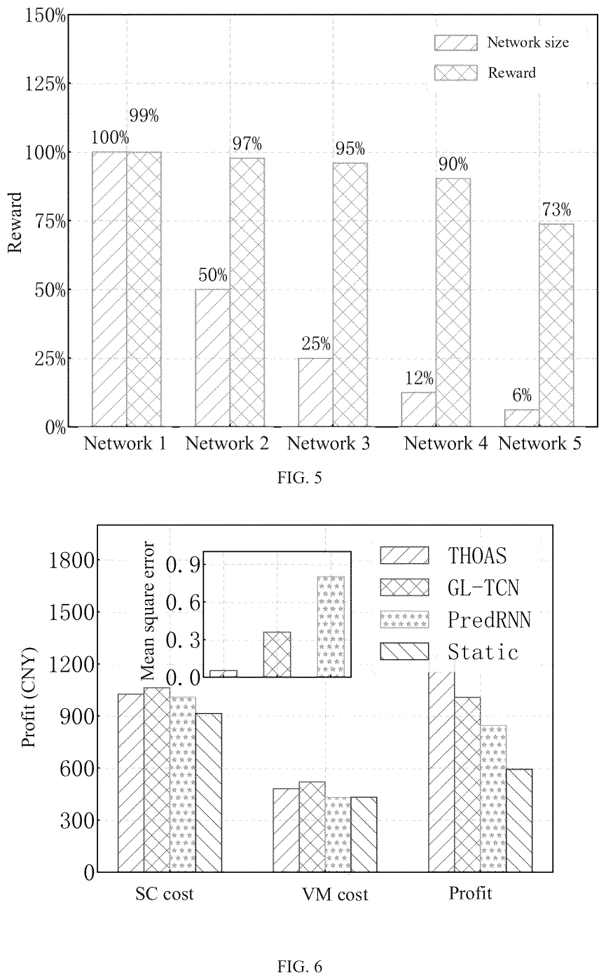

Then, impacts of using different traffic prediction methods on the ESP's return, cost, and profit are analyzed, where the ESP's return is composed of the cost and the profit. As shown in FIG. 6, when traffic prediction-based adaptive slicing is used, the cost is slightly higher than that of the Static method, but a significantly improved return and profit can be obtained. The reason is that when the user traffic is increased, a static slice resource cannot satisfy the user requirement, which results in that the completion time of some tasks exceeds the maximum task tolerant latency, and therefore, the ESP cannot obtain a corresponding return. Similarly, when the user traffic is reduced, the proposed adaptive network slicing may also curtail resources, thereby avoiding an unnecessary resource cost. Compared with the GL-TCN and the PredRNN, the proposed THOAS may obtain higher traffic prediction accuracy. Therefore, the return and profit obtained are higher. The reason is that a traffic prediction model based on ProbSparse self-attention can better capture a phased traffic fluctuation in the SAGIN. Therefore, prediction performance of the model is superior to the other methods. A result shows that the proposed traffic prediction-based adaptive slicing may effectively improve the ESP's profit.

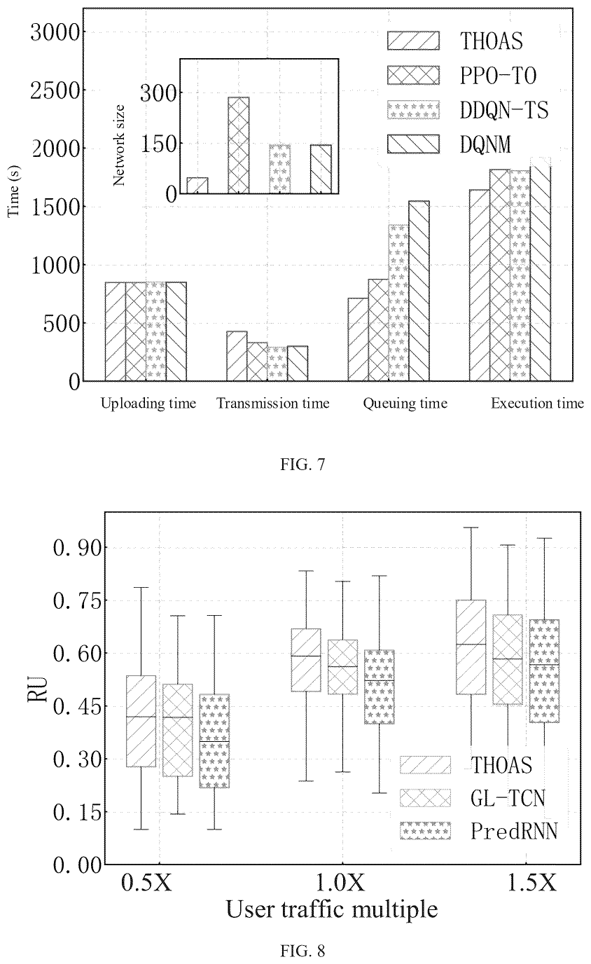

Then, the task completion time using different methods is compared. It is composed of task uploading time, transmission time, queuing time, and execution time. Because the channel allocation policy is fixed, the uploading time of the above four methods is the same. As shown in FIG. 7, compared with the other three methods, the DQNM generates longer task queuing time. The reason is that the DQNM cannot dispatch a task to an appropriate virtual machine, resulting in an excessively long task waiting queue on some virtual machines. Compared with the PPO-TO and the DDQN-TS, the THOAS has longer transmission time but shorter execution time and queuing time. The reason is that when traffic in the SAGIN is increased to a certain extent, user requirements in the coverage of an unmanned aerial vehicle may exceed a computation capability of the unmanned aerial vehicle. For the problem, the THOAS forwards the task to a ground base station for execution through a wireless link in the SAGIN, and the ground base station has a higher computation frequency. Therefore, the queuing time and the execution time are correspondingly reduced. It can be seen from the figure that under this layered offloading framework, the transmission time caused by task forwarding is less than the saved queuing time and execution time. Therefore, the total task completion time of the THOAS is less than that of the other methods. In addition, the network size of the PPO-TO method is greater than those of the DQNM and the DDQN-TS, and the reason is that the PPO-TO selects and evaluates an offloading action by using an actor-critic structure which is more complex than the Q network used by the DQNM and the DDQN-TS. Compared with the other methods, the THOAS effectively compresses the network scale by using the distillation technology, which significantly reduces model complexity and training overheads, and is more suitable for the SAGIN having a resource-limited device (for example, an unmanned aerial vehicle).

Then, impacts of user traffic changes on RU using different methods are compared. As shown in FIG. 8, when traffic is changed from 1.0× to 0.5×, the RU is significantly reduced. The reason is that when the traffic is reduced, an opportunity for the resource rented by the ESP to be utilized is reduced. In some time slots, the traffic even approaches 0, but the ESP still needs to maintain a basic resource to ensure service availability. Therefore, a phenomenon that the RU equals to 0 occurs. It should be noted that sparse traffic may cause an increase in a prediction error. Therefore, compared with the 1.0× traffic, resource utilization in a scenario of 0.5× traffic is lower. However, when the traffic is increased from 1.0× to 1.5×, the RU is slightly increased. The reason is that when the user traffic is increased, a probability for the resource additionally rented by the ESP to be utilized is higher, and less resources are in an idle state. Therefore, higher RU is caused. Compared with the GL-TCN and the PredRNN, the THOAS may obtain higher traffic prediction accuracy and higher RU, which shows that better prediction model performance helps improve the resource utilization in the SAGIN.

Then, impacts of the maximum task tolerant latency on DVR using different methods are compared. As shown in FIG. 9, the DVR is significantly reduced with an increase of the maximum task tolerable latency. The reason is that there is more time to complete the task. Therefore, a proportion of violating the maximum task tolerable latency is reduced. When the maximum task tolerable latency is continuously increased, the DVR may approach 0, which illustrates that the resource rented by the ESP may better satisfy the user requirement. Compared with the PPO-TO and the DDQN-TS, the THOAS can complete more tasks within the same maximum task tolerable latency, thereby implementing a lower DVR. The reason is that the THOAS improves decision performance by using generalized advantage estimation and proximal policy clipping based on a dynamic confidence interval, and can adaptively make a more appropriate decision in different scenarios, thereby completing more tasks.

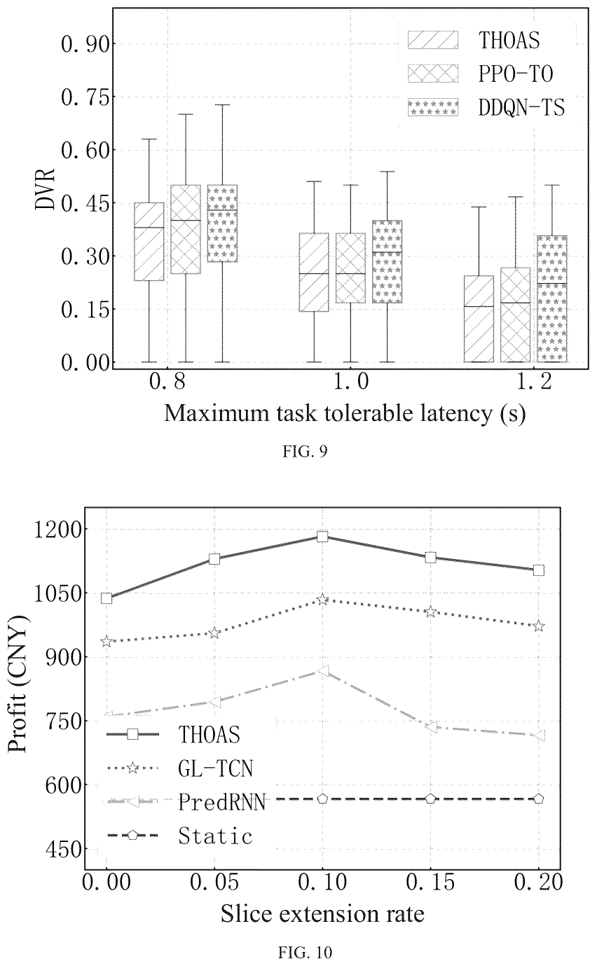

Then, impacts of a slice extension rate δ on the ESP's profit are analyzed. As shown in FIG. 10, with an increase of δ, the EPS's profits using different methods are all increased first and then decreased. The reason is that when δ is relatively low, the additionally rented resource may not satisfy requirements of all tasks so that some tasks cannot be completed within the maximum task tolerant latency, resulting in a relatively low profit of the ESP. With an increase of δ, the additionally rented resource is increased when slice adjustment is performed. Therefore, the above problem may be alleviated, thereby improving the ESP's profit. When δ is continuously increased, the ESP's profit starts to be reduced. The reason is that the cost of the additionally rented resource exceeds the return brought by the additionally rented resource, resulting in a decrease of the ESP's profit. The above result shows that the ESP's profit may be increased while the cost is maintained by appropriately renting the additional resource based on an expected resource obtained through computation by the THOAS. When δ is different, the performance of the THOAS is superior to that of the other methods, which shows superior performance of the proposed accurate traffic prediction and adaptive network slicing for improving the ESP's profit.

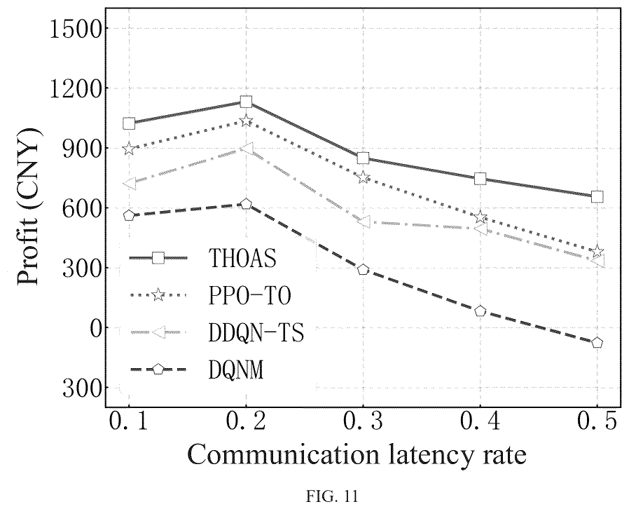

Then, impacts of a communication latency rate ω on the ESP's profit are analyzed. As shown in FIG. 11, with an increase of ω, the ESP's profits using different methods are all increased first and then decreased. The reason is that when ω is relatively low, the task uploading time is strictly limited. In this case, the ESP needs to allocate more sub-channels to the task, and correspondingly, the ESP's fees for renting the resource are also increased. With an increase of ω, there is more task uploading time. Therefore, the above problem is alleviated. However, with a continuous increase of ω, the task queuing latency and execution time are correspondingly reduced. At this time, the execution frequency of a virtual machine in the SAGIN may not satisfy a task requirement, causing that some tasks exceed the maximum task tolerant latency, thereby reducing the ESP's profit. The above result shows that the THOAS divides the maximum tolerant latency into a communication latency and a computation latency, which may improve the capability of the THOAS to sense a system requirement, thereby increasing the ESP's profit. Compared with the PPO-TO, the DDQN-TS, and the DQNM, the proposed THOAS can achieve the highest profit of the ESP in different communication scenarios, which shows the THOAS's superiority in processing an offloading problem in the SAGIN.

The above-described embodiments are only exemplary embodiments of the present invention and constitute no restriction in any form on the present invention. Those skilled in the art may make some changes or modifications to equivalent embodiments with equivalent changes by reference to the technical content disclosed above. However, any simple revisions, equivalent changes, and modifications made to the above embodiments in accordance with the technical essence of the present invention without departing from the content of the technical solutions of the present invention shall still fall within the protection scope of the technical solutions of the present invention.

The present invention is not limited to the above exemplary embodiments, and anyone can derive other traffic-aware lightweight layered offloading frameworks for an adaptive slicing-enabled space-air-ground integrated network in various forms under the motivation of the present invention, and all equivalent changes and modifications made in accordance with the patent application scope of the present invention shall fall within the scope covered by the present invention.

What is claimed is:

1. A traffic-aware lightweight layered offloading framework for an adaptive slicing-enabled space-air-ground integrated network (SAGIN), wherein the adaptive slicing-enabled SAGIN is divided into a communication access platform (CAP) and a computation offloading platform (COP), and resources on each of the CAP and the COP are managed by network slicing; an edge service provider (ESP) provides computation offloading while performing resource allocation; for the resource allocation, a dynamic traffic change is captured by using ProbSparse self-attention, and adaptive network slicing is executed in accordance with predicted traffic and a system load; and for the computation offloading, a communication process and a computation process are separated to allocate a sub-channel as required in accordance with a channel state, then a virtual machine is allocated to a task through a lightweight computation offloading algorithm, and a converged policy is extracted as a lightweight neural network for online inference.

2. The traffic-aware lightweight layered offloading framework for the adaptive slicing-enabled space-air-ground integrated network of claim 1, wherein in a time slot start stage, first, slice resources are adjusted in accordance with historical traffic, load, and task completion information, and an adaptive network slicing algorithm is executed once every T^{slice} time slots to determine whether to adjust a slice; then, a user sends a to-be-offloaded task to the CAP closest to the user, and when neither a base station (BS) nor an unmanned aerial vehicle is available, the user sends the task to a satellite; after receiving an offloading request, the ESP allocates the sub-channel for the task and uploads the task to the CAP; next, the task of the user is transmitted from the CAP to the COP through a dedicated link in the adaptive slicing-enabled SAGIN; when the CAP is a ground base station and a satellite, the COP is a ground base station; when the CAP is an unmanned aerial vehicle, the COP is an unmanned aerial vehicle or a ground base station; then, after the task is transmitted to the COP, the task is allocated to a corresponding virtual machine for execution by invoking the lightweight computation offloading algorithm, and a result is transmitted back to a user device after computation is completed; and in a time slot end stage, the ESP collects task completion, system load, and user traffic information for profit computation and slice adjustment.

3. The traffic-aware lightweight layered offloading framework for the adaptive slicing-enabled space-air-ground integrated network of claim 2, wherein
the adaptive network slicing algorithm comprises the following steps:
S1: predicting future user traffic through a Transformer-based traffic prediction model:
first, construct input of an encoder and a decoder by using historical traffic information, wherein X^{his} represents historical access traffic, X^{cur} represents a traffic sequence collected by a current slice window, and X^{o} represents time sampling of a to-be-predicted traffic sequence; then, use the ProbSparse self-attention in the encoder and self-attention distillation between layers to reduce computation overheads, wherein a feature extraction process from a j^{th} layer to a j+1th layer is defined as follows:
$${X}_{j + 1}^{en} = MaxPool ( ELU ( {Convld ( [ {X}_{j}^{en} ] )}_{attention} ) ) ) \\ {[ ▪ ]}_{attention} = Softmax ( \frac{\overline{Q} {K}^{T}}{\sqrt{d}} ) V ,$$
wherein [⋅] attention represents sparse self-attention, d is a dimension of xₗ^{t}, Conv1d represents a one-dimensional convolution on a time sequence, ELU is an activation function, and MaxPool is a maximum pooling operation;
next, send output of the encoder and the input of the decoder to the decoder, wherein the decoder comprises a one-layer multi-head ProbSparse self-attention mechanism and a one-layer multi-head attention mechanism; and
finally, send the output of the encoder to a multi-layer perceptron (MLP), and obtain a future traffic prediction sequence through inference;
S2: computing an anticipated system load:
first, define a communication load and a computation load of a system respectively to accurately measure a slice load: the communication load under a time slot of t is represented as a ratio of a used channel resource to total channel resources, and the computation load is represented as a ratio of a sum of T^{que} and T^{ere} to
$${T}_{cop}^{ma x} ;$$
and
after obtaining the system load, compute an anticipated resource requirement by multiplying a historical load by a ratio of anticipated traffic to a historical traffic; and
S3: computing an expected slice resource and determining whether to adjust the slice:
first, take 1+δ times a load peak as the expected slice resource, wherein δ represents a proportion of resources additionally purchased by the ESP;
then, define a profit brought by adjusting the slice as follows:
$$Δ P = Δ R - Δ C$$
wherein W represents a difference between the ESP's anticipated return after adjusting the slice and the ESP's anticipated return when maintaining a current slice, and ΔC represents a difference between the ESP's cost after adjusting the slice and the ESP's cost when maintaining the current slice, and define an interruption cost caused by adjusting the slice as follows:
$${C}^{i n t} = {\sum }_{t = 1}^{{T}^{i n t}} {\sum }_{i = 1}^{{N}_{j}} Φ {ρ}_{i}$$
wherein T^{int} represents a quantity of time slots required for adjusting the slice; and
when a difference between the profit and the interruption cost that are brought by adjusting the slice is greater than 0, trigger slice adjustment, and adjust communication and computation slice resources to B^{*} and F^{*} respectively, and when the difference between the profit and the interruption cost is less than or equal to 0, keep the slice resources unchanged.

4. The traffic-aware lightweight layered offloading framework for the adaptive slicing-enabled space-air-ground integrated network of claim 2, wherein
the lightweight computation offloading algorithm is a computation offloading method in accordance with dynamic task traffic and a quantity of virtual machines to improve resource utilization in the adaptive slicing-enabled SAGIN and the ESP's profit, and interaction between a deep reinforcement learning (DRL) agent and an SAGIN environment is defined as a Markov decision process.

5. The traffic-aware lightweight layered offloading framework for the adaptive slicing-enabled space-air-ground integrated network of claim 4, wherein a state space, an action space, and a reward function in the Markov decision process are defined as follows:
the state space: a virtual machine (VM) task queue of the ESP's slice, a task attribute, and a user priority for task sending are comprised; and a maximum computation tolerable latency and a central processing unit (CPU) cycle required by the task are converted into a computation frequency to represent a computation resource required by the task;
the action space: when a virtual machine of the unmanned aerial vehicle is difficult to satisfy offloading requirements of all tasks, the task is forwarded to a BS for offloading; and action spaces adapted to different scenarios are defined as follows: when the task is executed at the BS, the action space comprises a target virtual machine; when the task is executed on the unmanned aerial vehicle, the action space comprises the target virtual machine and forwarding to the BS for execution; and VM_{G} is used to represent that the task is forwarded to the BS through an SAGIN wireless link, and the task is reallocated to a virtual machine at the BS; and
the reward function: in accordance with an optimization target, the reward function is defined as a profit obtained by completing the task; when the task is forwarded from the unmanned aerial vehicle to the BS, the profit is computed at the BS; and a positive value is used as a reward to distinguish between a forwarded task and a failed task.

6. The traffic-aware lightweight layered offloading framework for the adaptive slicing-enabled space-air-ground integrated network of claim 4, wherein in the lightweight computation offloading algorithm:
first, a network parameter and an environment are initialized; for each received task, a state Sₜ is input to a participant network, and then the DRL agent explores an offloading action in a current state in accordance with π;
after receiving the action, the SAGIN environment executes the action and feeds back a state Sₜ₊₁ an instant reward Sₜ₊₁ and a time slot state ωₜ of a next task, wherein ωₜ represents whether the task is a final task in a current time slot and used for computing a discounted reward; and then, a sample of a state transition function is stored in a buffer;
when a network is updated, to reduce an impact of noise caused by the task attribute on gradient estimation, generalized advantage estimation is introduced as a network update target and defined as follows:
$${\hat{A}}_{t} = {\sum }_{k = 0}^{∞} {( γ λ )}^{k} {δ}_{t + l} \\ {δ}_{t} = {R}_{t} + γ V ( {s}_{t + 1} ) - V ( {s}_{t} )$$
wherein γ is a reward discount rate, λ is an advantage function discount rate, δₜ is a time differentiation error, Rₜ is a reward, and V is a state value function; and a reward for a subsequent task in the current time slot is used for computing the discounted reward, and Rₜ is defined as follows:
$${R}_{t} = {\sum }_{k = 0}^{N - 1} {γ}^{k} {R}_{t + k + 1}$$
a clipping mechanism is used to ensure that each update is within a given range, and an objective function of policy update is defined as follows:
$${L}^{actor} ( θ ) = E [ min ( r ( θ ) \hat{A} ( {s}_{t} , {a}_{t} ) , \tilde{r} ( {θ}_{t} ) \hat{A} ( {s}_{t} , {a}_{t} ) ) ]$$
wherein r(θ) is a ratio between sample weights of a new policy and an old policy and defined as follows:
$$r ( θ ) = \frac{{π}_{θ} ( {a}_{t} \vert {s}_{t} )}{{π}_{old} ( {a}_{t} \vert {s}_{t} )}$$
a two-layer dynamic confidence interval is used and defined as follows:
$$\tilde{r} ( {θ}_{t} ) = \{ \begin{matrix}1 - {α}_{t} , if ( 1 - {α}_{t} ) \leq r ( {θ}_{t} ) < 1 \\ 1 + {α}_{t} , if 1 < r ( {θ}_{t} ) \leq ( 1 + {α}_{t} ) \\ clip ( r ( {θ}_{t} ) , 1 - ò , 1 + ò ) , otherwise\end{matrix}$$
wherein ò is a clipping ratio, αₜ is a dynamic confidence factor dynamically adjusted in accordance with a temporal differentiation error, and αₜ is defined as follows:
$${α}_{t} = \{ \begin{matrix}{κα}_{t - 1} , {δ}_{t - 1} \geq 0 \\ {α}_{t - 1} / κ , otherwise\end{matrix}$$
κ is used to control an update speed of the dynamic confidence factor; and then, a critic network is optimized by minimizing L^{critic}(ϕ) represented as follows:
$${L}^{critic} ( ϕ ) = {E ( {R}_{t} + γ V ( {S}_{t + 1} ) - V ( {S}_{t} ) )}^{2}$$
after all rounds of training are performed, the converged policy executes an offloading decision through interaction with the adaptive slicing-enabled SAGIN;
to obtain experience of a teacher model in the adaptive slicing-enabled SAGIN, the teacher model is used to interact with the environment, and a state transition sample is stored in the buffer; and then, the state transition sample is randomly selected from the buffer for policy distillation; and
for each of the samples, a policy of a teacher network is used as a learning target and an Adam optimizer is used to train a student network to output an action probability distribution similar to that output by the teacher network; this process is considered as supervised learning; and a loss function is constructed by using a soft label and Kullback-Leibler (KL) divergence and defined as follows:
$${L}^{dis} ( {θ}_{s} ) = {\sum }_{i = 1}^{K} Softmax ( \frac{{q}_{k}^{T}}{τ} ) ln \frac{Softmax ( \frac{{q}_{k}^{T}}{τ} )}{Softmax ( {q}_{k}^{S} )} .$$
wherein
$${q}_{k}^{T} and {q}_{k}^{S}$$
are action probability distributions output by the teacher model and a student model respectively, and τ is a temperature; and an action probability after being subjected to softmax is set as a distillation target.

7. The traffic-aware lightweight layered offloading framework for the adaptive slicing-enabled space-air-ground integrated network of claim 2, wherein an operating process of the traffic-aware lightweight layered offloading framework comprises the following steps:
(1) collecting historical user traffic of the ESP, predicting future user traffic, computing a resource requirement of the ESP, and executing adaptive network slice adjustment by the ESP at an interval in accordance with the resource requirement;
(2) responding, by an infrastructure provider, to the resource requirement of the ESP, dividing the network slice therefor, and charging a corresponding cost;
(3) accessing and uploading a computation offloading request to the ESP by the user through the adaptive slicing-enabled SAGIN;
(4) allocating the CAP and the COP for the user in accordance with the user's location, and generating a sub-channel and virtual machine allocation policy in accordance with a task attribute and a user priority; and
(5) recording, by the traffic-aware lightweight layered offloading framework (THOAS), user traffic, state, used action, obtained reward, and new transitioned state information of each time slot in a computation offloading process, and continuously optimizing performance in accordance with the user traffic, state, used action, obtained reward, and new transitioned state information.
